(19) United States
(12) Patent Application Publication
(10) Pub. No.: US 2013/0199196 A1
(43) Pub. Date: Aug. 8, 2013

(54) SYSTEM AND METHOD FOR GAS TURBINE PART LOAD EFFICIENCY IMPROVEMENT

(71) Applicants: Rahul Chillar, Atlanta, GA (US); Vijay Nenmeni, Atlanta, GA (US); Julio Enrique Mestroni, Atlanta, GA (US); Jianmin Zhang, Greer, SC (US); James Patrick Tomey, Simpsonville, SC (US)

(72) Inventors: Rahul Chillar, Atlanta, GA (US); Vijay Nenmeni, Atlanta, GA (US); Julio Enrique Mestroni, Atlanta, GA (US); Jianmin Zhang, Greer, SC (US); James Patrick Tomey, Simpsonville, SC (US)

(73) Assignee: GENERAL ELECTRIC COMPANY, Schenectady, NY (US)

(21) Appl. No.: 13/367,624

(22) Filed: Feb. 7, 2012

(51) Int. Cl. F02C 9/00

(52) U.S. Cl. 60/773; 60/39.24

(57) ABSTRACT

In one embodiment of the present disclosure, a gas turbine system for part load efficiency improvement is described. The system includes a gas turbine having a compressor which receives inlet-air. An evaporative cooler system using heated fluid heats the inlet-air before the inlet-air flows to the compressor. Heating the inlet-air reduces an output of the gas turbine and extends the turndown range.

### FIELD OF THE INVENTION

The subject matter disclosed herein relates generally to gas turbines, and more specifically to methods and apparatus for operating gas turbines.

### BACKGROUND OF THE INVENTION

The present invention relates to the operation of a gas turbine, and more particularly to systems and methods for part load efficiency improvement in a gas turbine.

Turbo machines, such as gas turbines, aero-derivatives, or the like, commonly operate in a combined-cycle and/or cogeneration mode. In combined-cycle operation, a heat recovery steam generator, which generates steam, receives the exhaust-gas from the gas turbine; the steam then flows to a steam turbine that generates additional electricity. In a co-generation operation, a portion of the steam generated by the heat recovery steam generator is sent to a separate process requiring the steam.

Combined-cycle and cogeneration plants are rated to generate the maximum amount of energy (mechanical, electrical, etc.) while operating at base load. However, base load operation, though desired by operators, is not always feasible. There may not be a demand in the energy market (electrical grid, or the like) for all of the energy generated at base load. Here, the power plant must either shutdown or operate at part load, where less than the maximum amount of energy is generated. Furthermore, part load operation tends to decrease the overall efficiency and increase the heat rate of the power plant.

Gas turbines are typically required to maintain emissions compliance while generating power. A gas turbine operating at part load, may not maintain emissions compliance over the entire part load range, (from spinning reserve to near base load). Turndown range may be considered the loading range where the gas turbine maintains emissions compliance. A broad turndown range allows operators to maintain emissions compliance, minimize fuel consumption, and avoid the thermal transients associated with shutting down and restarting the power plant.

An air preheating system may reduce the extent of the aforementioned disadvantages associated with operating a gas turbine at part load. Conventional approaches have focused on utilization of exhaust gas from the heat recovery steam generator, or addition of separate heating mechanism, which can be quite costly. As such, an approach that minimizes hardware and installation would be desirable.

For the foregoing reasons, there is a need for gas turbine systems that are integrated with an air preheating system that utilizes existing components of the gas turbine. Methods related to the same should allow for extending the turndown range. The systems and methods should allow for a reduction in the fuel consumed by the gas turbine while operating at the part load range.

### BRIEF DESCRIPTION OF THE INVENTION

Aspects and advantages of the invention will be set forth in part in the following description, or may be obvious from the description, or may be learned through practice of the invention.

In one embodiment of the present disclosure, a gas turbine system for part load efficiency improvement is described. The system includes a gas turbine having a compressor which receives inlet-air. An evaporative cooler system using hot water heats the inlet-air before the inlet-air flows to the compressor. Heating the inlet-air reduces an output of the gas turbine and extends the turndown range.

In another embodiment, a method of controlling a gas turbine system operation for part load efficiency improvement is described. The method includes utilizing an evaporative cooler system using hot water to heat inlet-air before the inlet-air flows to a gas turbine compressor. The method further includes feeding the gas turbine compressor the heated inlet-air, wherein the heated inlet-air reduces an output of the gas turbine and extends the turndown range.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended figures, in which:

FIG. 1 provides a schematic diagram of the gas turbine in accordance with various aspects of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

The present disclosure is generally directed to systems and methods for part load efficiency improvements in gas turbines. The systems and methods described herein have the technical effect of extending a gas turbine turndown range by heating the air entering the compressor of the gas turbine (hereinafter “inlet-air”). As described below, the inlet-air is heated by an evaporative cooling system that may already be present in connection with many gas turbines. In such embodiments, the evaporative cooling system can be repurposed to heat an air stream in addition to simply cooling it.

During base load operation, the combustion system may ensure that the exhaust-gas flowing out of the stack meets the site emissions requirements. Depending on the turndown range of the gas turbine, certain part load operations may violate the site emissions requirements, which may require the shutdown of the gas turbine. An increase in the turndown range may avoid the need to shutdown the gas turbine. Also, an extended turndown range allows for operating the gas turbine at lower loads, while maintaining emissions compliance and consuming less fuel.

The present invention extends the turndown range by heating the inlet-air. In accordance with the present disclosure, the extended turndown range is from about 5% to about 40% of the maximum rated load of the gas turbine. Generally, the output (electrical, mechanical, or the like) of a gas turbine is governed by the amount of mass-flow entering the compressor. The mass-flow may be considered the product of the density and the volume-flow of the inlet-air entering the compressor. The amount of volume-flow entering the compressor may vary on the ambient temperature conditions and the angle of Inlet Guide Vanes (IGVs), if present on the gas turbine. The IGV angle may determine the flow area at the inlet of the compressor. The IGV angle may be reduced to a minimum angle, limiting the amount of turndown. At the minimum IGV angle, a corresponding minimum volume-flow is drawn into the compressor.

In accordance with the present disclosure, the heating of the inlet-air decreases the density, allowing less dense inlet-air to enter the compressor. Here, at a given load point the volume-flow entering the compressor may remain constant, however the mass-flow decreases due to the decrease in density of the inlet-air. As discussed, the output of the gas turbine may be determined by the mass-flow entering the gas turbine; therefore less output is produced due to the heating of the inlet-air, compared to not heating the inlet-air.

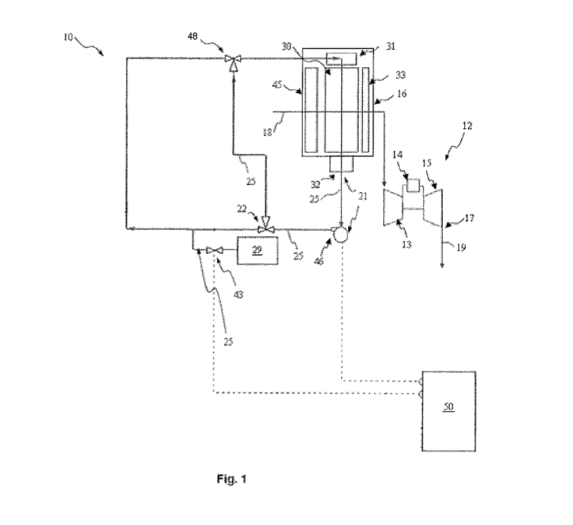

FIG. 1 is a schematic diagram of a gas turbine inlet heating system 10 in accordance with various aspects of the present disclosure, the system operably connected to a gas turbine 12. The gas turbine 12 may include a compressor 13, combustor 14, and turbine 15. The gas turbine 12 may further include, for example, more than one compressor, more than one combustor, and more than one turbine (not shown). The gas turbine 12 may include a gas turbine inlet 16. The inlet 16 may be configured to receive gas turbine inlet air flow 18. For example, in one embodiment, the inlet 16 may be a gas turbine inlet house. The gas turbine 12 may further include a gas turbine exhaust outlet 17. The outlet 17 may be configured to discharge gas turbine exhaust flow 19. In one embodiment, the exhaust flow 19 may be directed to a heat recovery steam generator (“HRSG”) (not shown). In another embodiment, the exhaust flow 19 may be dispersed into ambient air. In another embodiment, the exhaust flow may be directed to an evaporative cooler system as will be described in more detail herein.

The gas turbine inlet heating system 10 may include an evaporative cooler system 30. Absorption chillers generally have low power requirements compared to mechanical and electrical chillers, and are energy efficient when, for example, waste heat is used as the heat source. For example, in one embodiment, the heat source 29 may be generated by the gas turbine 12. For example, the heat source 29 may be gas turbine exhaust 19. In another embodiment, the heat source 29 may be generated by a HRSG. For example, the heat source 29 may be HRSG water or HRSG steam. In other embodiments, the heat source 29 may be any waste steam, such as steam turbine sealing steam, waste hot water, generator cooling water, or heat flow generated by any heat-producing process. It should be understood that the heat source 29 is not limited to waste heat and exhaust heat sources, but may be supplied through any heating method, such as, for example, solar heating, auxiliary boiler heating or geothermal heating.

In one embodiment, the evaporative cooler system 30 may be configured to allow the heating fluid flow 25 to pass through the evaporative cooler 30. For example, the evaporative cooler 30 may include a heating fluid inlet 31 and a heating fluid outlet 32. In one embodiment, the heating fluid inlet 31 may be a nozzle. In another embodiment, the heating fluid inlet 31 may be a plurality of heating inlets 31. For example, the heating fluid inlet 31 may be a plurality of nozzles. The heating fluid inlet 31 may act to communicate the heating fluid flow 25 to the evaporative cooler system 30.

In an exemplary aspect of an embodiment, the heating fluid outlet 32 may include a sump 46 disposed downstream of the evaporative cooler system 30 in the direction of heating fluid flow 25. The sump 46 may be configured to collect the heating fluid flow 25 after it has passed through the evaporative cooler 30, including any resultant condensate from the heating process. The heating fluid is then recirculated to the evaporative cooler system 30.

The sump 46 and/or return line/heating fluid outlet 32 can include one or more temperature sensor 21. In this regard, sump 46 typically includes a conductivity sensor (not shown) that triggers blowdown once the conductivity level reaches a pre-determined threshold value. This mechanism can prevent corrosion issues from liquid carryover. In accordance with the present disclosure, when the temperature sensor 21 indicates that the temperature of the heating fluid falls below a predefined temperature, circulation to a heating source is initiated by three-way valve element 22. The heating fluid that follows the re-circulation path can be filtered through a water purification skid (not shown) and then reheated from heat source 29 before being re-circulated back to evaporative cooler system 30. Additionally, in certain aspects of the present disclosure, when one or more temperature sensor 21 indicate that the temperature of the heating fluid falls below a predefined temperature, heating fluid flow can be adjusted to the evaporative cooler system by valve 48. In this manner, there can be reliable assurance that the heating fluid will not cool prematurely and prevent heating of the air that passes through the evaporative cooler system. In addition, in modes where the evaporative cooler system functions to cool the air that passes therethrough, the temperature sensor inputs can be disregarded such that re-circulation and blowdown occur based on conductivity sensor measurements alone.

Evaporative cooler system 30 may be configured to receive inlet air flow 18. For example, in one embodiment, evaporative cooler system 30 may be situated upstream of the gas turbine inlet 16 in the direction of inlet air flow 18. In one embodiment, the evaporative cooler system 30 may be situated adjacent to the gas turbine inlet 16. In another embodiment, the evaporative cooler system 30 may be situated inside the gas turbine inlet 16. Inlet air flow 18 may be directed through evaporative cooler system 30 before entering gas turbine inlet 16 or compressor 13.

The evaporative cooler system 30 may be configured to heat the inlet air flow 18 as the inlet air flow 18 passes through the evaporative cooler system 30. For example, the evaporative cooler system 30 may be configured to allow inlet air flow 18 passing through the evaporative cooler system 30 to interact with the heating fluid flow 25, thereby heating the inlet air flow 18. In one embodiment, the inlet air flow 18 may be directed through the heating fluid flow 25, such that the inlet air flow 18 cools the heating fluid flow 25, thereby heating the inlet air flow 18.

In one embodiment, heating fluid flow 25 may be directed in a generally downward direction over the media surface. In one embodiment, the inlet air flow 18 may be directed through the evaporative cooler 30 in a direction substantially perpendicular to the direction of the heating fluid flow 25. For instance, as heating fluid flow contacts media surfaces, heat and moisture can be released into the air flow. The heating fluid typically has a temperature of about 80 degrees Fahrenheit or greater, such as about 100 degrees Fahrenheit or about 200 degrees Fahrenheit. The heating fluid should always have a temperature substantially greater than the dry bulb temperature of air to overcome cooling due to evaporation. Generally, the temperature of the unheated inlet-air 18 may be determined by the ambient conditions or the outlet temperature of any air conditioning system (not illustrated) located upstream of the present inlet heating system 10. An embodiment of the present invention may increase the temperature of the inlet-air to any temperature allowed for by the inlet heating system. For example, the system 10 may increase the temperature of the inlet-air 18 from approximately 59 degrees Fahrenheit to approximately 120 degrees Fahrenheit. In certain embodiments, the inlet-air is heated to a range of about 10 to about 200 degrees Fahrenheit above an unheated temperature of the inlet-air. In certain embodiments, the inlet-air is heated to a range of about 5 to about 100degrees Fahrenheit above an unheated temperature of the inlet-air.

In a further exemplary aspect of an embodiment, a filter 45 may be disposed upstream of the evaporative cooler system 30 in the direction of inlet air flow 18. The filter 45 may be configured to remove particulate from the inlet air flow 18 prior to the inlet air flow 18 entering the evaporative cooler system 30 and the gas turbine 12. In another embodiment, a filter 45 may be disposed downstream of the evaporative cooler system 30 in the direction of inlet air flow 18. The filter 45 may be configured to remove particulate from the inlet air flow 18 prior to the inlet air flow 18 entering the gas turbine 12. In one embodiment, a drift eliminator 33 may be disposed downstream of the evaporative cooler system 30 in the direction of inlet air flow 18. The drift eliminator 33 may act to remove droplets of fluid from the gas turbine inlet air flow 18 prior to the gas turbine inlet air flow 18 entering the gas turbine 12.

The gas turbine inlet heating system 10 may be configured such that operation of the system 10 is regulated in relation to certain conditions. For example, a controller 50 may be operably connected to the gas turbine power augmentation system 10 to regulate the system. In one embodiment, the controller 50 may be operably connected to the evaporative cooler system 30 and configured to regulate operation of the evaporative cooler system 30. Controller 50 can also be in communication with one or more temperature sensor 21 and re-circulation valve 22 and flow valve 48. The controller 50 may be programmed with various control algorithms and control schemes to operate and regulate gas turbine inlet heating system 10 and evaporative cooler system 30.

The present disclosure contemplates a controller that has the effect of controlling the operation of a gas turbine integrated with an inlet heating system of the present disclosure. In certain embodiments of the present disclosure, the controller can be configured to automatically and/or continuously monitor the gas turbine to determine whether the inlet heating system should operate. The controller 50 can be any suitable controller mechanism as would be known in the art and may further be operably connected to other elements of the gas turbine inlet heating system 10 or the gas turbine 12. In other embodiments, the controller 50 may be operably connected to other components of the gas turbine power augmentation system 10 or the gas turbine 12 to maximize the output or efficiency of gas turbine 12.

The present disclosure can be utilized to retrofit existing systems and can also be used in connection with new systems. For instance, the present disclosure can be utilized in connection with evaporative coolers that have multiple levels. In such embodiments, each level typically includes a return line/heating fluid outlet 32 that flows to a common sump 46. In such embodiments, temperature sensors 21 can be placed at each return line to ensure that heating fluid retains acceptable temperatures as previously described herein.

In certain aspects of the present disclosure a method of controlling a gas turbine system operation for part load efficiency improvement is described. The method includes utilizing an evaporative cooler system as described herein to heat inlet-air before the inlet-air flows to a gas turbine compressor. The method further includes feeding the gas turbine compressor the heated inlet-air, wherein the heated inlet-air reduces an output of the gas turbine and extends the turndown range.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine system for part load efficiency improvement comprising:
a gas turbine comprising a compressor, which receives inlet-air; and
an evaporative cooler system, the evaporative cooler system being configured to heat the inlet-air using heated fluid before the inlet-air flows to the compressor, wherein heating the inlet-air reduces an output of the gas turbine and extends the turndown range.

2. The system of claim 1, wherein an extended turndown range comprises from about 5% to about 90% of the maximum rated load of the gas turbine.

3. The system of claim 1, wherein the inlet-air is heated to a range of about 10 to about 200 degrees Fahrenheit above an unheated temperature of the inlet-air.

4. The system of claim 1, wherein the inlet-air is heated to a range of about 5 to about 100 degrees Fahrenheit above an unheated temperature of the inlet-air.

5. The system of claim 1, further comprising a sump, the sump configured to collect liquid from the evaporative cooler system to recirculate the liquid back to the evaporative cooler system.

6. The system of claim 5, wherein the sump comprises a temperature sensor.

7. The system of claim 6, wherein the temperature sensor is linked to a controller that controls a re-circulation valve in the sump.

8. The system of claim 1, wherein the evaporative cooler system comprises a return line.

9. The system of claim 8, wherein the return line comprises a temperature sensor.

10. The system of claim 7, wherein the temperature sensor is in communication with a controller that controls the flow of liquid to the evaporative cooler system.

11. The system of claim 1, wherein the evaporative cooler system comprises two or more levels.

12. A method of controlling a gas turbine system operation for part load efficiency improvement, the method comprising:
utilizing an evaporative cooler system to heat inlet-air using heated fluid before the inlet-air flows to a gas turbine compressor;
feeding the gas turbine compressor the heated inlet-air; and
wherein the heated inlet-air reduces an output of the gas turbine and extends the turndown range.

13. The method of claim 13, wherein an extended turndown range comprises from about 5% to about 40% of the maximum rated load of the turbo machine.

14. The method of claim 13, further comprising heating the inlet-air to a range of about 10 to about 200 degrees Fahrenheit above an unheated temperature of the inlet-air.

15. The method of claim 13, further comprising heating the inlet-air to a range of about 5 to about 100 degrees Fahrenheit above an unheated temperature of the inlet-air.

16. The method of claim 12, further comprising a sump, the sump utilized to collect liquid from the evaporative cooler system to recirculate the liquid back to the evaporative cooler.

17. The method of claim 16, wherein the sump comprises a temperature sensor.

18. The method of claim 17, wherein the temperature sensor is in communication with a controller, the controller controlling a re-circulation valve in the sump.

19. The method of claim 12, wherein the evaporative cooler system comprises a return line.

20. The method of claim 19, wherein the return line comprises a temperature sensor that is in communication with a controller, the controller controlling the flow of liquid to the evaporative cooler system.
